(19) United States
(12) Patent Application Publication
(10) Pub. No.: US 2006/0016418 A1
(43) Pub. Date: Jan. 26, 2006

(54) Fuel injector and a method of sealing the same

(75) Inventors: Tsuneaki Aoki, Obu-shi (JP); Masami Tatsukawa, Obu-shi (JP); Toshiro Makimura, Obu-shi (JP)

Correspondence Address: DENNISON, SCHULTZ, DOUGHERTY & MACDONALD, 1727 KING STREET, SUITE 105, ALEXANDRIA, VA, 22314, US

(73) Assignee: Aisan Kogyo Kabushiki Kaisha

(21) Appl. No.: 11/178,609

(22) Filed: Jul. 12, 2005

(30) Foreign Application Priority Data
Jul. 20, 2004 (JP) JP 2004-211500
Sep. 28, 2004 (JP) JP 2004-282045

(51) Int. Cl. F02M 57/04

(52) U.S. Cl. 123/296; 239/585.1; 123/470

(57) ABSTRACT

A movable core 31 can move with respect to a fixed core 21. A bobbin 51 on which a coil 52 is wound is disposed around the fixed core 21. A body 22 is disposed around the bobbin 51. A connector 24 is formed of resin and disposed around the fixed core 21. A connecting wire 25 is connected to the coil 52 and embedded in the connector 24. A seal 27 is disposed in a region 26 that is surrounded by the fixed core 21, the connector 24 and the body 22, with the connecting wire 25 running through the seal 27.

### BACKGROUND OF THE INVENTION

1. Field of the Invention

The present invention relates to fuel injectors for internal combustion engines and a method of sealing the same.

2. Description of the Related Art

Typically, electromagnetic fuel injectors are used as fuel injectors for internal combustion engines.

An example of a known electromagnetic fuel injector is disclosed in Japanese non-examined laid-open patent publication No. 6-50235 and is reproduced in FIG. 10, which shows a sectional view of a fuel injector 210.

The fuel injector 210 includes a fixed core 221, a movable core 230, a bobbin 251 and a body 270. A coil 252 is wound on the bobbin 251 and develops electromagnetic force for driving the movable core 230. A fuel injector of this type is provided with a seal for preventing fuel from leaking to the outside. For example, a seal is provided in order to prevent fuel from leaking to the outside via a connecting wire 225 for supplying electric power to the coil 252. In the fuel injector 210 shown in FIG. 10, an O-ring 260a is disposed between the bobbin 251 and the fixed core 221, and an O-ring 260b is disposed between the bobbin 251 and the body 270.

When an O-ring is used as a seal, in order to achieve desirable characteristics, it is necessary to increase the outside diameter of the bobbin 251, accordingly the outside diameter of the body 270 which is disposed over the bobbin 251. To this end, the maximum diameter B1 of the body 270 is increased.

As shown in FIG. 10, the fuel injector 210 is installed into a mounting hole 282 of an intake manifold 280. The tip end of the fuel injector 210 must be located in a predetermined position such that the fuel that is injected through the fuel jet opening is mixed with air that is supplied via an intake passage 281 of the intake manifold 280 and such that the injected fuel is prevented from adhering to the inner wall of the intake manifold 280.

The maximum outside diameter B1 of the known fuel injector 210, which is at a portion that the bobbin 251 is disposed, is larger than the minimum inside diameter A of the mounting hole 282 of the intake manifold 280. Therefore, as shown in FIG. 10, a stepped mounting portion 270 is formed on the periphery of the fuel injector 210 below the portion having the bobbin 251 inside. Further, the length (“valve length”) H1 of the movable core 230 is increased so that the tip end of the fuel injector 210 is placed in position.

However, the movable core 230 increases in weight as it increases in length, so that the operating characteristics of the fuel injector 210 is impaired.

On the other hand, fuel injectors of another type are also known in which sealing is provided without using an O-ring. An example of the known fuel injector of this type is disclosed in Japanese non-examined laid-open patent publication No. 9-42110 and is reproduced in FIG. 9, which shows a sectional view of a fuel injector 110.

The fuel injector 110 includes a movable core 131. A ball valve 132 is mounted on the tip end of the movable core 131 and serves to open and close a fuel jet opening 141c of a valve seat body 141. A spring 134 is disposed between the movable core 131 and a spring adjuster 133 and normally urges the movable core 131 in the direction that causes the ball valve 132 to close the fuel jet opening 141c.

A radially outwardly protruding flange 121a is formed on the outer surface of the fixed core 121 in a predetermined position. A bobbin 151 is disposed around the fixed core 121 and a coil 152 is wound on the bobbin 151. A body 122 is disposed over the bobbin 151 and partially covers the periphery of the flange 121a of the fixed core 121. A hole 121b is formed through the flange 121a of the fixed core 121. A connecting wire 125 is placed in the hole 121b. One end of the connecting wire 125 is connected to the coil 152. A seal 127 is formed of glass and is disposed between the inner peripheral surface of the hole 121b and the connecting wire 125.

A connector 124 is formed of resin and is disposed around the fixed core 121. A socket 124a is formed in the connector 124 so that it can receive a connecting terminal which is connected to an external electric power source. The other end of the connecting wire 125 of which one end is connected to the coil 152 is located in the socket 124a.

In the known fuel injector 110 shown in FIG. 9, the connecting wire 125 runs through the hole 121b of the flange 121a of the fixed core 121. Further, the seal 127 is provided between the inner peripheral surface of the hole 121b and the connecting wire 125. Thus, the need for an O-ring is eliminated, so that the maximum outside diameter of the body 122 can be made smaller than that of a fuel injector using an O-ring.

However, the outside diameter of the flange 121 of the fixed core 121, or the outside diameter of a portion of the body 122 which covers the periphery of the flange 121a of the fixed core 121, can be reduced only to a limited extent, because the seal 127 is provided in the hole 121b of the flange 121a of the fixed core 121. Accordingly, the length of the body 122 which is inserted into the mounting hole 282 of the intake manifold 280, or the length of the movable core 131, can not be decreased.

Further, it is necessary to provide an additional sealing mechanism between the flange 121a of the fixed core 121 and the body 122.

### SUMMARY OF THE INVENTION

Accordingly, it is an object of the present invention to provide a fuel injector and a method of sealing the same, in which the maximum outside diameter of the body of the fuel injector can be reduced and the sealing structure can be made simpler.

In one aspect of the invention, a seal is provided in a region that is surrounded by a fixed core, a body and a connector, in the state in which a connecting wire is connected to a coil and runs through the region. Thus, it is not necessary to provide a seal in a flange of the fixed core. Therefore, the outside diameter of the flange of the fixed core, or the outside diameter of a portion of the body which contacts the flange (the maximum outside diameter of the body), can be reduced.

Preferably, the seal may be elastic. The seal may be preferably provided in a region that is surrounded by the fixed core, the flange that is formed on the surface of the fixed core and protrudes radially outward, the body and the connector.

In order to form the seal of a sealing material having low viscosity, preferably, the region may be first formed and then the sealing material is filled into the region. For example, the fixed core and the connector are positioned with respect to the body such that the region surrounded by the fixed core, the connector and the body communicates with an inlet hole formed in the body. After the sealing material has been filled into the region, the fixed core and the connector are positioned with respect to the body such that the region does not communicate with the inlet hole. In this case, preferably, the fixed core and the connector may be positioned with respect to the body by press-fitting. Of course, the body can be positioned with respect to the fixed core and the connector.

In another aspect of the invention, a seal is provided in a region that is surrounded by the body and the connector, in the state in which the connecting wire is connected to the coil and runs through the region. In this manner, too, it is not necessary to provide a seal in the flange of the fixed core. Therefore, the outside diameter of the flange of the fixed core, or the outside diameter of a portion of the body which contacts the flange (the maximum outside diameter of the body), can be reduced.

Preferably, the seal may be elastic. The seal may be preferably provided in a region that is surrounded by the body and a recess formed on the outer peripheral surface of the connector.

In order to form the seal of a sealing material having low viscosity, preferably, the region may be first formed and then the sealing material is filled into the region. For example, the connector is positioned with respect to the body such that the region that is surrounded by the body and the recess formed on the outer peripheral surface of the connector communicates with the inlet hole formed in the body. After the sealing material has been filled into the region, the connector is positioned with respect to the body such that the region does not communicate with the inlet hole. In this case, preferably, the connector may be positioned with respect to the body by press-fitting. Of course, the body can be positioned with respect to the connector.

In another aspect of the invention, the maximum outside diameter of the body of the fuel injector is smaller than the minimum inside diameter of a mounting hole of an intake manifold. In this case, the greater part of the body of the fuel injector can be inserted into the mounting hole of the intake manifold. Therefore, the length of the movable core of the fuel injector can be shortened, so that the operating characteristics of the fuel injector can be improved. Further, the coil is cooled by the intake air within the intake manifold, so that the operating characteristics of the fuel injector 10 is stabilized.

Other objects, features and advantages of the present invention will be readily understood after reading the following detailed description together with the accompanying drawings and the claims.

### BRIEF DESCRIPTION OF THE DRAWINGS

FIG. 1 is a sectional view showing a fuel injector according to an embodiment of the invention.

FIG. 2 is a sectional view taken along line II-II in FIG. 1.

FIG. 3 is a sectional view taken along line III-III in FIG. 1.

FIG. 4 shows an example of a method of providing a seal in the fuel injector according to the embodiment of the invention.

FIG. 5 shows the example of the method of providing the seal in the fuel injector according to the embodiment of the invention.

FIG. 6 is a sectional view showing a fuel injector according to another embodiment of the invention.

FIG. 7 is a sectional view taken along line VII-VII in FIG. 6.

FIG. 8 shows an example of a method of providing a seal in the fuel injector according to the second embodiment of the invention.

FIG. 9 is a sectional view showing a prior art fuel injector.

FIG. 10 is a sectional view showing a prior art fuel injector mounted to an intake manifold.

FIG. 11 is a sectional view showing the fuel injector of the present invention which is mounted to an intake manifold.

### DETAILED DESCRIPTION OF THE INVENTION

According to the present invention, a representative fuel injector may includes a fixed core, a movable core that can move with respect to the fixed core, a coil holding element that is disposed around the fixed core, a connector that is disposed around the fixed core and in which a connecting wire is embedded, the connecting wire being connected to the coil on the coil holding element, and a body that is disposed around the coil holding element.

Typically, the fixed core has a radially outwardly protruding flange. The coil holding element is disposed on the downstream side of the flange of the fixed core with respect to the direction of fuel flow. Further, the connector is formed of resin.

In one embodiment of the present invention, a seal is provided in a region that is surrounded by the fixed core, the body and the connector, with the connecting wire running through the region. Specifically, in this embodiment, the connecting wire that is connected to the coil on the coil holding element runs through the flange of the fixed core, the seal provided in the region, and the connector. In this embodiment, it is not necessary to provide a seal for sealing the connecting wire in the flange of the fixed core. Therefore, the outside diameter of the flange of the fixed core, or the outside diameter of a portion of the body which contacts the flange, can be reduced.

Suitably, the seal is provided in a region that is surrounded by the fixed core, the flange of the fixed core, the body and the connector, with the connecting wire running through the region. In this case, the region for the seal can be readily formed.

The seal and the connector may be formed of the same material or of different materials. Further, the seal and the connector may be formed separately or integrally.

Further, in this embodiment, it is not necessary to provide an additional seal between the fixed core and the body. Therefore, the sealing structure can be made simpler and the work for sealing can be made more easily.

Further, it is not necessary to provide an additional seal (particularly on the downstream side). Therefore, the coil (the coil holding element that holds the coil) can be freely positioned with respect to the boundary between the fixed core and the movable core. For example, the boundary between the fixed core and the movable core can be positioned in the middle of the coil in the axial direction. In this case, the efficiency and the operating characteristics of the fuel injector can be improved.

Various methods may be used to place the seal in the region.

For example, in one method, the seal is formed, in advance, with the connecting wire extending through the seal, and the seal is placed in the region. In another method, first, the region is formed, and thereafter, sealing material is filled into the region.

When sealing material of low viscosity is used, the latter method is preferably used. For example, the fixed core and the connector are positioned with respect to the body such that the region that is surrounded by the fixed core, the connector and the body communicates with the inlet hole formed in the body. Then the sealing material is filled into the region. Thereafter, the fixed core and the connector are positioned with respect to the body such that the region does not communicate with the inlet hole. In order to position the fixed core and the connector with respect to the body, suitably, the fixed core, the coil holding element, the coil and the connector are assembled together into one piece such that a fixed core body is made and the fixed core body is positioned with respect to the body by press-fitting. Of course, the body can be positioned with respect to the fixed core body.

In another embodiment of the present invention, a seal is provided in a region that is surrounded by the body and the connector, with the connecting wire running through the region. In this embodiment as well, the connecting wire that is connected to the coil on the coil holding element runs through the flange of the fixed core, the seal provided in the region, and the connector. Thus, it is not necessary to provide a seal in the flange of the fixed core. Therefore, the outside diameter of the flange of the fixed core, or the outside diameter of a portion of the body which contacts the flange, can be reduced.

Suitably, the seal is provided in a region that is surrounded by the body and a recess formed on the outer peripheral surface of the connector, with the connecting wire running through the region. In this case, the region for the seal can be readily formed simply by forming the recess on the outer peripheral surface of the connector.

In this embodiment as well, it is not necessary to provide an additional seal between the fixed core and the body. Thus, the sealing structure can be made simpler and the work for sealing can be made more easily. Further, the coil can be freely positioned with respect to the boundary between the fixed core and the movable core.

The above-mentioned method can be available to place the seal in the region.

When sealing material of low viscosity is used, for example, the connector is positioned with respect to the body such that the region that is surrounded by the connector and the body communicates with the inlet hole formed in the body. Then the sealing material is filled into the region. Thereafter, the connector is positioned with respect to the body such that the region does not communicate with the inlet hole. In order to position the connector with respect to the body, suitably, the fixed core, the coil holding element, the coil and the connector are assembled together into one piece such that a fixed core body is made and the fixed core body is positioned with respect to the body by press-fitting. Of course, the body can be positioned with respect to the fixed core body.

Typically, a fuel injector is installed into a mounting hole of an intake manifold.

In a preferred embodiment of this invention, the outside diameter of a portion of the body which contacts the flange (the maximum outside diameter of the body) is smaller than the minimum inside diameter of the mounting hole of the intake manifold. In this case, the greater part of the body of the fuel injector can be inserted into the mounting hole of the intake manifold. Therefore, the length of the movable core (“the valve length”) can be shortened. Accordingly, the weight of the movable core can be reduced, so that the operating characteristics of the fuel injector can be improved.

Further, when the greater part of the body of the fuel injector is inserted into the mounting hole, the coil of the fuel injector is placed within the intake manifold. Thus, the coil of the fuel injector is cooled by the intake air within the intake manifold. Therefore, the influence of heat can be alleviated, so that the operating characteristics of the fuel injector is stabilized.

Each of the additional features and method steps disclosed above and below may be utilized separately or in conjunction with other features and method steps to provide improved fuel injectors and methods of sealing such fuel injectors. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention.

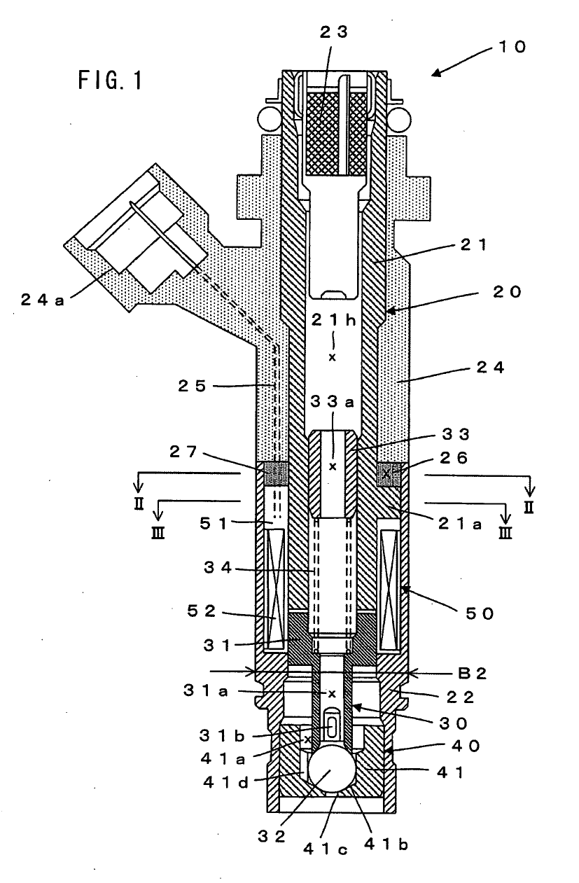

FIG. 1 shows a fuel injector 10 according to an embodiment of the present invention, in sectional view.

The fuel injector 210 includes an injector body 20, a valve 30, a valve seat 40 and a driving section 50.

The injector body 20 has a generally cylindrical shape. The inner space of the injector body 20 serves as a fuel passage 21h. Fuel flows through the fuel passage 21h from top to bottom in FIG. 1. The injector body 20 has a fixed core 21 on the upstream side and a body 22 on the downstream side with respect to the direction of fuel flow. The fixed core 21 and the body 22 are formed of magnetic material. A fuel filter 23 is mounted in the upstream portion of the fuel passage 21h. A flange 21a is formed on the outer peripheral surface of the fixed core 21 in a predetermined position and protrudes radially outward.

The valve 30 includes a movable core 31 and a ball valve 32 that is disposed on the downstream side of the movable core 31. The movable core 31 is formed of magnetic material. The movable core 31 has a generally cylindrical shape. The inner space of the movable core 31 serves as a fuel passage 31a. Further, a communication hole 31b is formed through the side wall of the movable core 31 and serves to communicate the fuel passage 31a with a fuel passage 41a of a valve seat body 41 which will be described below. The ball valve 32 has a spherical shape. The valve 30 is disposed such that it can move in the axial direction of the fuel injector 10 (vertically as viewed in FIG. 1) with respect to the injector body 20 and the valve seat 40. In this embodiment, the movable core 31 is disposed such that it can slide along the inner peripheral surface of the body 22.

The valve seat 40 has a valve seat body 41. The valve seat body 41 is mounted with the body 22, for example, by press-fitting. The valve seat body 41 has a generally cylindrical shape with a bottom. A sealing surface (contact surface) 41b and a fuel jet opening 41c are formed in the bottom of the valve seat body 41. The inner space of the valve seat body 41 serves as a fuel passage 41a. A groove 41d is formed in a portion of the inner peripheral surface of the valve seat body 41 which faces the ball valve 32 and extends in the axial direction (vertically as viewed in FIG. 1). Fuel can be led from the fuel passage 41a to the fuel jet opening 41c via the groove 41d. The fuel jet opening 41c is closed when the ball valve 32 is in contact with the sealing surface 41b, while the fuel jet opening 41c is opened when the ball valve 32 is not in contact with the sealing surface 41b.

Further, a spring 34 is disposed between a spring adjuster 33 and the valve 30 (the movable core 31) and normally urges the valve 30 toward the valve seat 40 (in the direction that closes the fuel jet opening 41c).

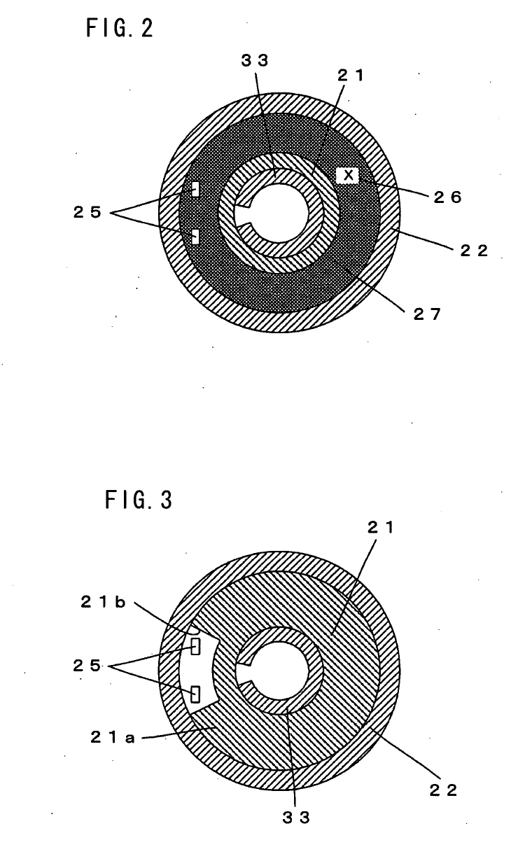

As shown in FIG. 2, the spring adjuster 33 has a generally C-shaped cross section and is fixedly fitted in a predetermined position within the fixed core 21, for example, by press-fitting or caulking. The biasing force that urges the valve 30 toward the valve seat 40 can be adjusted by adjusting the position of the spring adjuster 33 to be fixed. The spring adjuster 33 may have various configurations.

The inner space of the spring adjuster 33 serves as a fuel passage 33a. Thus, fuel can pass through the fuel filter 23 and the fuel passages 21h, 33a, 31a, 41a and then be led to the fuel jet opening 41c via the groove 41d.

The fixed core 21 and the movable core 31 are arranged such that a slight clearance is formed between the fixed core 21 and the movable core 31 when the ball valve 32 of the valve 30 is in contact with the sealing surface 41b of the valve seat body 41.

The driving section 40 for driving the valve 30 includes the fixed core 21, a coil 52 and the body 22. A bobbin 51 is disposed around the fixed core 21 and the coil 52 is wound on the bobbin 51. The bobbin 51 is a feature that corresponds to the “coil holding element” according to this invention. The bobbin 51 on which the coil 52 is wound is typically covered with resin. An end portion of a connecting wire 25 of which end is connected to the coil 52 is embedded in the resin, for example, by insert molding.

The body 22 has a generally cylindrical shape. The body 22 is disposed over the bobbin 51 such that the outer peripheral surface of the flange 21a of the fixed core 21 contacts the inner peripheral surface of the body 22. For example, the body 22 is press fitted over the fixed core 21. Further, the body 22 and the fixed core 21 are arranged such that the upstream end (upper end as viewed in FIG. 1) of the body 22 is located on the upstream side of the flange 21a.

A connector 24 is formed of resin and disposed over the fixed core 21. A socket 24a is formed in the connector 24 and can receive a connecting terminal which is connected to an external electric power source. One end of the connecting wire 25 is connected to the coil 52 and the other end is placed in the socket 24a. Thus, the coil 52 can be connected to the external electric power source via the connecting wire 25. The connecting wire 25 for connection between the coil 52 and the external electric power source may be composed of one or more connecting wires. A plurality of the connecting wires may be connected in series.

The fixed core 21, the body 22 and the connector 24 are arranged so as to define a region 26. In this embodiment, the region 26 is defined by the fixed core 21, the flange 21a of the fixed core 21, a portion of the body 22 which protrudes upstream from the flange 21a, and the connector 24.

The connecting wire 25 and a seal 27 are placed in the region 26. For example, the seal 27 may be provided in the region 26 with the connecting wire 25 running through the region 26. The seal 27 can be formed of various sealing materials, and preferably of elastic sealing materials, such as rubber. Sealing effectiveness of the seal 27 can be enhanced by using elastic materials. Further, the seal 27 is formed of insulating material. The seal 27 may be formed of materials having any additional characteristic as necessary.

FIG. 2 is a sectional view taken along line II-II in FIG. 1 and shows the state in which the connecting wire 25 and the seal 27 are placed in the region 26. As shown in FIG. 2, the connecting wire 25 runs through the region 26 that is defined by the outer peripheral surface of the fixed core 21 and the inner peripheral surface of the body 22, and the seal 27 is provided in the region 26. In this embodiment, the region 26 is defined into a cylindrical (doughnut-like) shape by the outer peripheral surface of the fixed core 21 that is circular in section and the inner peripheral surface of the body 22 that is also circular in section. The seal 27 having a cylindrical (doughnut-like) shape is provided in the region 26. The connecting wire 25 runs through the seal 27 in the axial direction.

Further, the connecting wire 25 is running through the flange 21a of the fixed core 21. This state is shown in FIG. 3, which is a sectional view taken along line III-III in FIG. 1. As shown in FIG. 3, a recess 21b is formed in the outer peripheral surface of the flange 21a of the fixed core 21. The recess communicates in the axial direction (in the vertical direction as viewed in FIG. 1).

Various methods may be used to place the connecting wire 25 in the region of the flange 21a of the fixed core 21.

In one method, one end portion of the connecting wire 25 which juts out of the bobbin 51 with the one end connected to the coil 52 is placed in the recess 21b of the flange 21a of the fixed core 21. Then the recess 21b is filled with resin, so that the connecting wire 25 is fixed in the recess 21b.

In another method, in the process of covering the bobbin 51 on which the coil 52 is wound, with resin, a protrusion which protrudes from the bobbin 51 and has a shape corresponding to the shape of the recess 21b is formed of resin with a portion of the connecting wire 25 of which end is connected to the coil 52 being embedded in the protrusion. And, when the bobbin 51 is disposed around the fixed core 21, the protrusion in which the connecting wire 25 is embedded is fitted in the recess 21b so as to fix the connecting wire 25 in the recess 21b.

Various methods may be used to place the connecting wire 25 and the seal 27 in the region 26.

In one method, first, the bobbin 51 is fitted onto the fixed core 21 with the coil 52 which is wound on the bobbin 51 being covered with the resin and a portion of the connecting wire 25 of which end is connected to the coil 52 being embedded in the resin. At this time, the bobbin 51 is aligned in the circumferential direction such that the connecting wire 25 running from the bobbin 51 is placed in the recess 21b of the flange 21a. Then, the body 22 is fitted over the bobbin 51. At this time, the connecting wire 25 that runs from the bobbin 51 via the flange 21a is placed in a region (corresponding to the region 26) which is defined by the fixed core 21, the flange 21a of the fixed core 21, and the portion of the body 22 which extends upstream from the flange 21a. Subsequently, the sealing material is filled into this region. Then, the connector 24 is formed of resin over the fixed core 21.

The seal 27 and the connector 24 may be formed independently at different times or at about the same time. In either way, the seal 27 is provided in the region 26, which is defined by the fixed core 21, the flange 21a of the fixed core 21, the portion of the body 22 which extends upstream from the flange 21a, and the connector 24, with the connecting wire 25 running through the region 26.

In another method, first, the bobbin 51 is fitted onto the fixed core 21 with the coil 52 which is wound on the bobbin 51 being covered with the resin and a portion of the connecting wire 25 of which end is connected to the coil 52 being embedded in the resin. At this time, the bobbin 51 is aligned in the circumferential direction such that the connecting wire 25 is placed in a predetermined position. Then, in this state, the connector 24 is formed of resin over the fixed core 21 such that a region is defined by the fixed core 21, the flange 21a, of the fixed core 21 and the connector 24. In this manner, the connecting wire 25 is embedded in the connector 24. Then, the body 22 is fitted over the bobbin 51. Subsequently, sealing material is filled, through an inlet hole formed in the body 22, into the region 26 which is defined by the fixed core 21, the flange 21a of the fixed core 21, the portion of the body 22 which extends upstream from the flange 21a, and the connector 24. The sealing material is then hardened. Thus, the seal 27 is provided in the region 26 with the connecting wire 25 running through the region 26.

In a further different method, first, the bobbin 51 is fitted onto the fixed core 21 with the coil 52 which is wound on the bobbin 51 being covered with the resin and a portion of the connecting wire 25 of which end is connected to the coil 52 being embedded in the resin. Then, the body 22 is fitted over the bobbin 51. Subsequently, sealing material is filled into a region which is defined by the fixed core 21, the flange 21a of the fixed core 21 and the portion of the body 22 which extends upstream of the flange 21a and into a region in which the connector 24 is to be formed. In this manner, the seal 27 is provided in the region 26 with the connecting wire 25 running through the region 26, and at the same time, the connector 24 is formed over the fixed core 21. In this method, the seal 27 and the connector 24 are integrally formed of the sealing material. In this embodiment, a portion of the integrally formed body which is corresponding to the region 26 is a feature that corresponds to the “seal provided in a region that is surrounded by the fixed core, the body and the connector” in this invention.

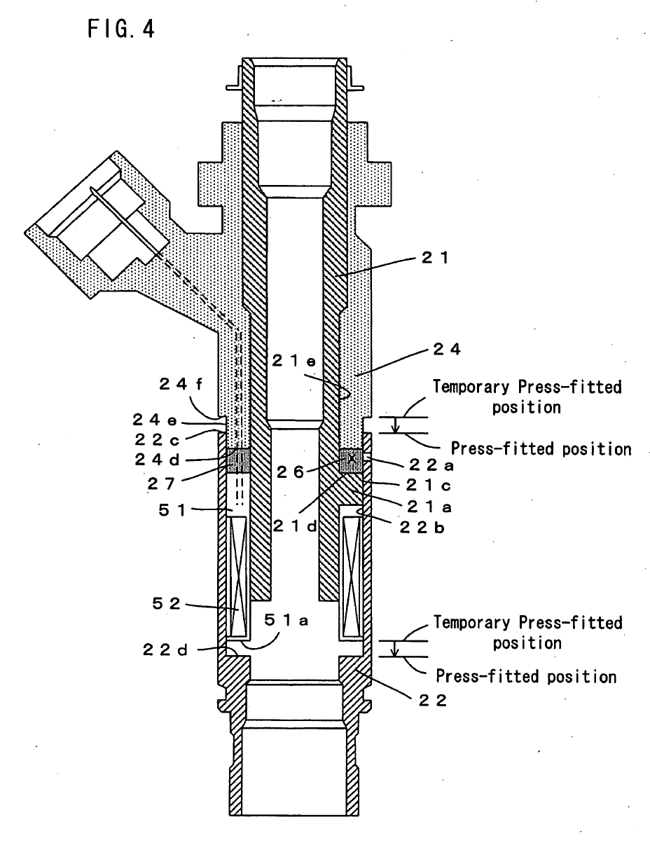

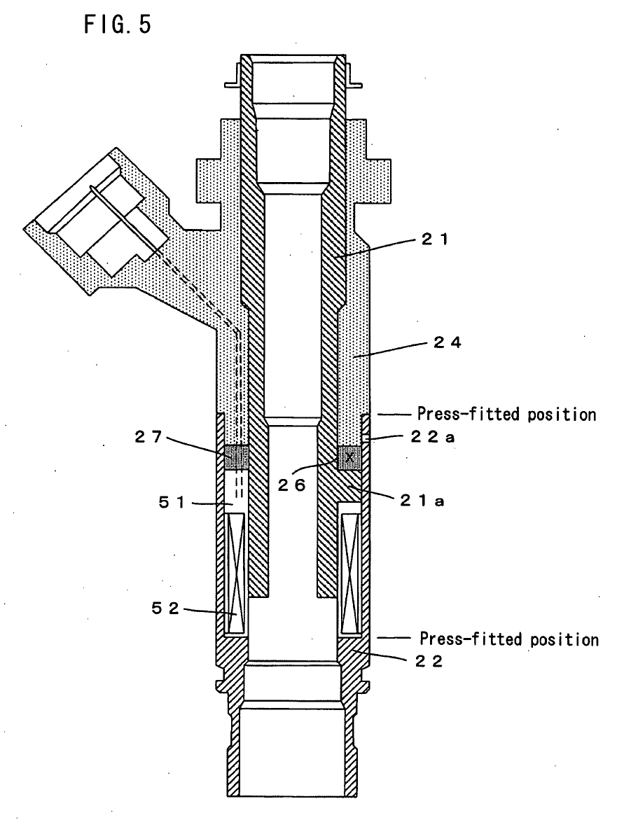

A sealing material having low viscosity may be used to form the seal 27. In such a case, it is difficult to provide the seal in the above-mentioned methods. An example of the method of providing the seal 27 in the region 26 which is surrounded by the fixed core 21, the body 22 and the connector 24, by using a sealing material having a low viscosity, will now be described with reference to FIGS. 4 and 5.

When sealing material of low viscosity is used, the body 22 as shown in FIGS. 4 and 5 is used. An upstream end 22c of the body 22 is located on the upstream side of the normal position of the region 26 which is surrounded by the fixed core 21, the body 22 and the connector 24. Further, an inlet hole 22a through which the sealing material is injected into the region 26 is formed through the body 22 on the upstream side of the normal position of the region 26. The inlet hole 22a may be of any design and configuration through which the sealing material can be injected into the region 26, and its shape, size, location and number can be appropriately chosen.

First, the bobbin 51 is fitted onto the fixed core 21 with the coil 52 which is wound on the bobbin 51 being covered with the resin and with a portion of the connecting wire 25 of which end is connected to the coil 52 being embedded in the resin. At this time, the bobbin 51 is aligned in the circumferential direction such that the connecting wire 25 is placed in a predetermined position. Then, in this state, the connector 24 is formed of resin over the fixed core 21 such that a region is defined by the fixed core 21, the flange 21a of the fixed core 21, and the connector 24. Thus, the coil 52, the bobbin 51, the connecting wire 25, the fixed core 21 and the connector 24 are assembled together into one piece (hereinafter referred to as a “fixed core body”). In this state, a recess is defined by the fixed core 21, the flange 21a of the fixed core 21, and the connector 24.

Subsequently, the fixed core body is fitted to the body 22. In this embodiment, as shown in FIG. 4, the fixed core body is press fitted into the body 22 from upstream (from above as viewed in FIG. 4). At this state, an outer peripheral surface 21c of the flange 21a and a downstream-side outer peripheral surface 24e of the connector 24 contact an inner peripheral surface 22b of the body 22. Consequently, the region 26 is defined by an outer peripheral surface 21e of the fixed core 21on the upstream side of the flange 21a, an upstream end surface 21d of the flange 21a, a downstream end surface 24d of the connector 24, and the inner peripheral surface 22b of the body 22.

In order to mount the fixed core body to the body 22, first, the fixed core body is positioned with respect to the body 22 in a position in which the sealing material can be injected into the region 26. In this embodiment, as shown in FIG. 4, the fixed core body is press fitted into the body 22 in the direction of the arrow until the region 26 reaches a position (“temporary press-fitted position”) in which the region 26 communicates with the inlet hole 22a of the body 22. At this state, as shown in FIG. 4, a predetermined axial extent of clearance is formed between a stepped end surface 24f of the connector 24 and the upstream-side end surface 22c of the body 22 and between a downstream-side end surface 51a of the bobbin 51 and a stepped surface 22d of the body 22. An appropriate position in which the region 26 communicates with the inlet hole 22a can be chosen as the temporary press-fitted position.

In the state in which the fixed core body is positioned in the temporary press-fitted position and the region 26 communicates with the inlet hole 22a, sealing material is filled into the region 26 through the inlet hole 22a. Thereafter, the inlet hole 22a is closed and then the region 26 is placed in the normal position.

In this embodiment, the fixed core body is further press fitted downstream (in the direction of the arrow) from the temporary press-fitted position to a position (“press-fitted position”) in which the stepped end surface 24f of the connector 24 contacts the upstream-side end surface 22c of the body 22. Thus, the fixed core body is positioned with respect to the body 22 in the press-fitted position. The downstream-side outer peripheral surface 24e of the connector 24 closes the inner end of the inlet hole 22a of the body 22 by the time that the fixed core body is positioned in the press-fitted position.

At this state, as shown in FIG. 5, the stepped end surface 24f of the connector 24 abuts on the upstream-side end surface 22c of the body 22, and the downstream-side end surface 51a of the bobbin 51 abuts on the stepped surface 22d of the body 22. An appropriate position in which the region 26 does not communicate with the inlet hole 22a can be chosen as the press-fitted position.

This press-fitted position corresponds to above “the normal position of the region 26”.

In this manner, even if the sealing material to be filled into the region 26 has low viscosity, the sealing material is prevented from flowing out of the region 26. Further, the sealing material which has been hardened is not squeezed out of the region 26 even if the fuel pressure is applied onto the sealing material.

Preferably, the fixed core body is moved from the temporary press-fitted position to the press-fitted position before the sealing material in the region 26 is hardened. Of course, the body 22 can be moved with respect to the fixed core body from the temporary press-fitted position to the press-fitted position.

Further, the fixed core body may be mounted to the body 22 by a method other than press-fitting.

Operation of this embodiment will now be explained.

When current is supplied to the coil 52, magnetic flux flows through the fixed core 21, the movable core 31 and the body 22 and thus a force to move the valve 30 (the movable core 31 and the ball valve 32) toward the fixed core 21 is generated. As a result, the valve 30 moves in a direction away from the valve seat 40 (upward as viewed in FIG. 1) against the biasing force of the spring 34. The valve 30 then stops in a position in which the movable core 31 contacts the fixed core 21.

At this state, the ball valve 32 separates from the sealing surface 41b of the valve seat body 41. Thus, the fuel jet opening 41c is opened and fuel is injected through the fuel jet opening 41c.

When the supply of current to the coil 52 is stopped in this state, the valve 30 moves in a direction toward the valve seat 40 (downward as viewed in FIG. 1) by the biasing force of the spring 34. The valve 30 then stops in a position in which the ball valve 32 contacts the sealing surface 41b of the valve seat body 41.

At this state, the fuel jet opening 41c is closed and the fuel injection from the fuel jet opening 41c is stopped.

As mentioned above, in this embodiment, the seal 27 is provided in the region 26 which is surrounded by the fixed core 21, the flange 21a of the fixed core 21, the body 22 and the connector 24, with the connecting wire 25 running through the region 26.

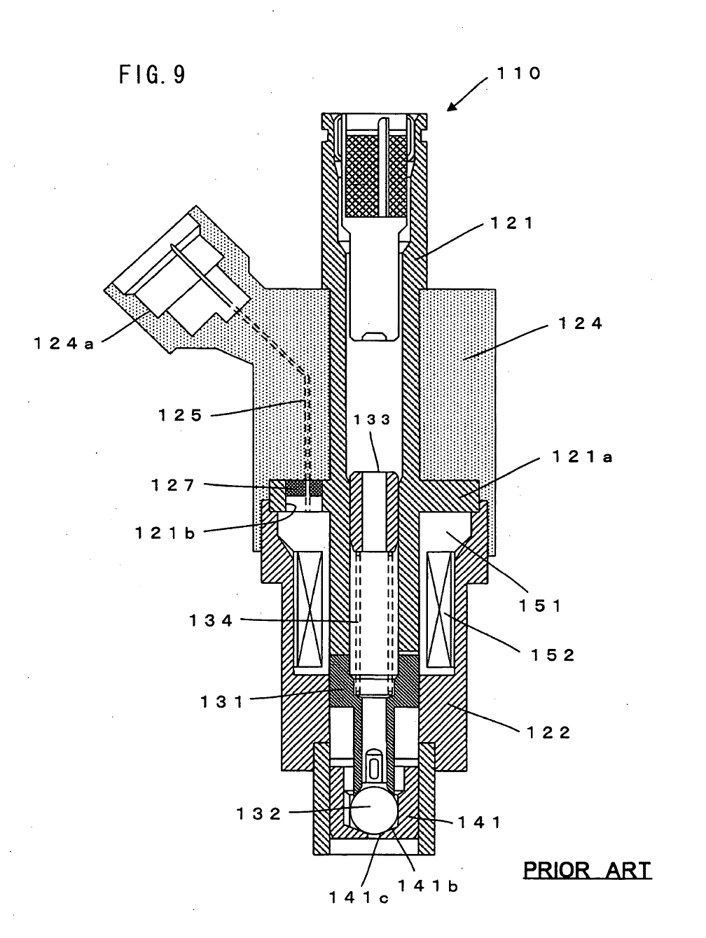

In this regard, in the prior art shown in FIG. 9, the seal 127 is provided in the hole 121b of the flange 121a of the fixed core 121, with the connecting wire 125 running through the hole 121b. Therefore, in the prior art, the outside diameter of the flange 121a of the fixed core 121, or the outside diameter of a portion of the body 122 which contacts the flange 121a (the maximum outside diameter of the body 122), can be reduced only to a limited extent. Further, it is necessary to provide an additional sealing mechanism between the flange 121a of the fixed core 121 and the body 122.

In contrast to this prior art, in this embodiment, the seal 27 is not provided in the flange 21a of the fixed core 21. Therefore, the outside diameter of the flange 21a of the fixed core 21 can be reduced to the smallest possible diameter with which the connecting wire 25 does not contact the fixed core 21 and the body 22. Further, the flange 21a can have about the same outside diameter as the bobbin 51. Therefore, compared with the prior art, it is possible to make smaller the outside diameter of the flange 21a of the fixed core 21, or the outside diameter of a portion of the body 22 which contacts the flange 21a (the maximum outside diameter of the body 122). Further, it is not necessary to provide an additional seal between the fixed core 21 and the body 22.

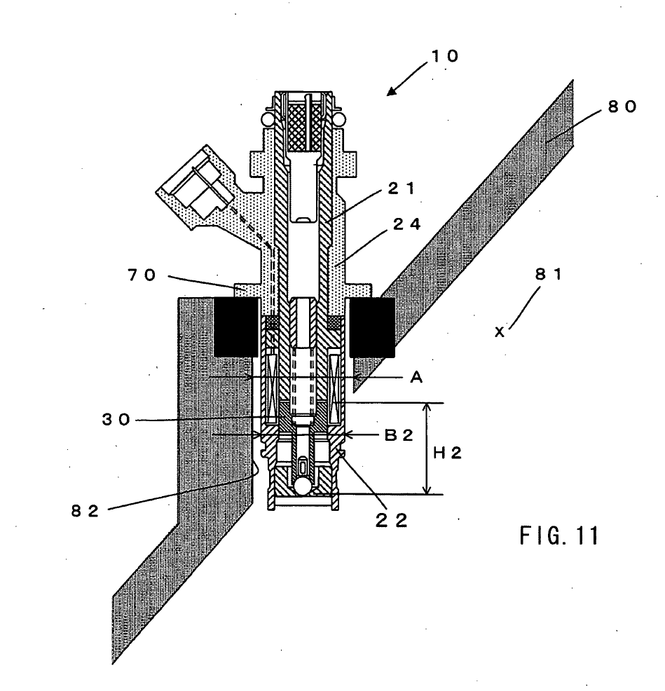

Thus, as shown in FIG. 11, in this embodiment, the maximum outside diameter B2 of the body 22 of the fuel injector 10 can be made smaller than the minimum inside diameter A of a mounting hole of an intake manifold 80.

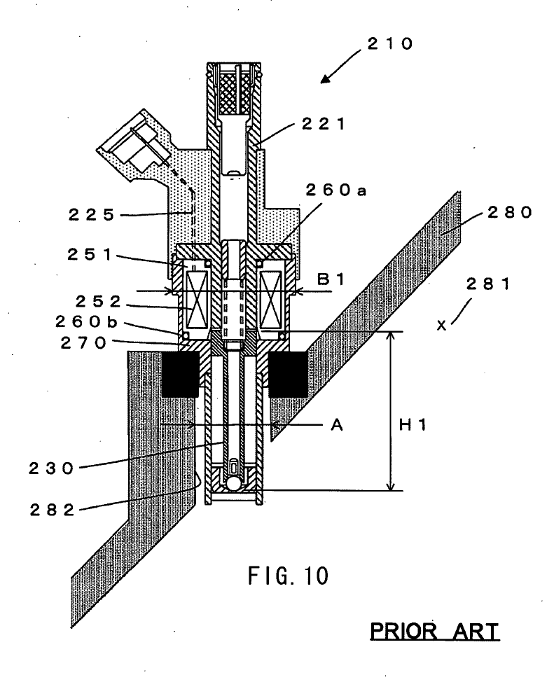

In this case, the greater part of the body 22 of the fuel injector 10 can be inserted into the mounting hole 82. Therefore, the length of the movable core 31, or the valve length H2, can be made shorter than the valve length H1 of the prior art shown in FIG. 10. Accordingly, the weight of the movable core 31 is reduced, so that the operating characteristics of the fuel injector 10 can be improved.

Further, the fuel injector 10 can be mounted to the intake manifold 80 such that the coil 52 is inserted into the intake manifold 80. Thus, the coil 52 can be cooled by the intake air within the intake manifold 80. Therefore, the influence of heat can be alleviated, so that the operating characteristics of the fuel injector 10 is stabilized.

Further, in FIG. 11, a stepped mounting portion 70 is provided on the outer peripheral surface of the fuel injector 10 and serves to position the tip end (e.g. the fuel jet opening) of the fuel injector 10. When the stepped mounting portion 70 is provided, the maximum outside diameter of a portion of the body 22 excluding the mounting portion 70 corresponds to the “the maximum outside diameter of the body” according to this invention.

Further, in this embodiment, an O-ring or any other similar seal is not provided on the downstream side of the flange 11a. Therefore, the degree of freedom in design of the position of the coil 52 with respect to the boundary between the fixed core 21 and the movable core 31 can be increased. For example, the boundary between the fixed core 21 and the movable core 31 can be positioned in the middle of the coil 52 in the axial direction. In this case, the efficiency and the operating characteristics of the fuel injector 10 can be improved.

In the above-mentioned embodiment, the region 26 for the seal has been described as being defined by the fixed core (the fixed core 21 and the flange 21a of the fixed core 21), the body (a portion of the body 22 which protrudes upstream from the flange 21a of the fixed core 21) and the connector 24, but a method of forming the region 26 for the seal is not limited to this. Further, the region 26 can be formed partially along the circumferential direction around the fixed core 21.

Another embodiment of the present invention will now be described. In this embodiment, the region for the seal is defined by the connector and the body.

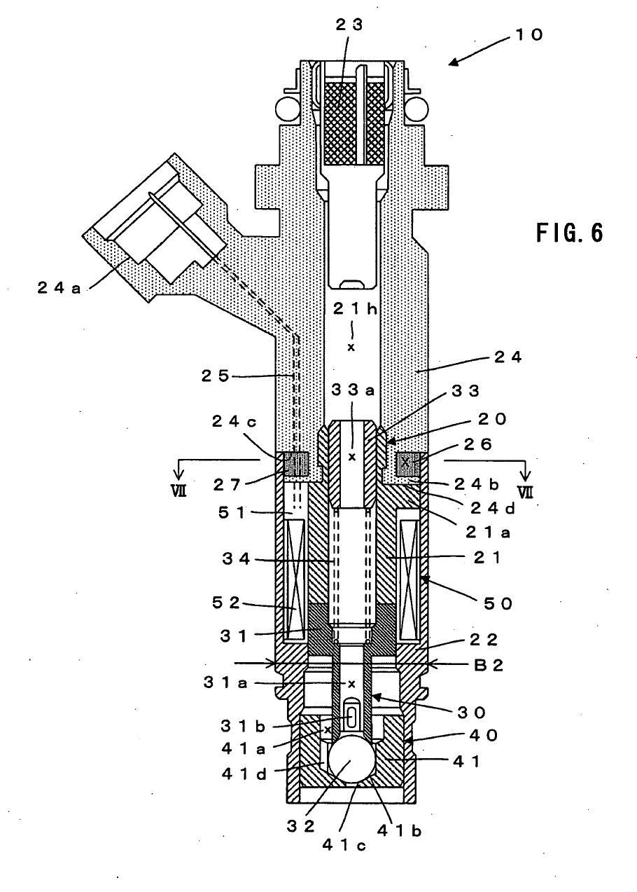

FIG. 6 is a sectional view showing the fuel injector 10 according to this embodiment of this invention. Components identical to those shown in FIG. 1 are given like numerals as in FIG. 1. The embodiment shown in FIG. 6 is different from the embodiment shown in FIG. 1 in configuration of the fixed core 21 and the connector 24. Therefore, only the different points will now be described.

In this embodiment, a recess 24c is formed on the outer peripheral surface of the connector 24 along the circumferential direction. Further, the connector 24 has an end wall 24b formed between the recess 24c and a downstream-side end surface 24d of the connector 24 on the side of the flange 21a. The downstream-side end surface 24d (lower end surface as viewed in FIG. 6) of the connector 24 is in contact with the upstream-side surface 21d (upper surface as viewed in FIG. 6) of the flange 21a.

Further, the body 22 is disposed such that the inner peripheral surface 22b of the body 22 contacts the outer peripheral surface 21c of the flange 21a and the outer peripheral surface of the end wall 24b of the connector 24.

Thus, the region 26 is defined by the connector 24 (the recess 24c of the connector 24) and the body 22 (a portion of the body 22 which protrudes upstream from the flange 21a).

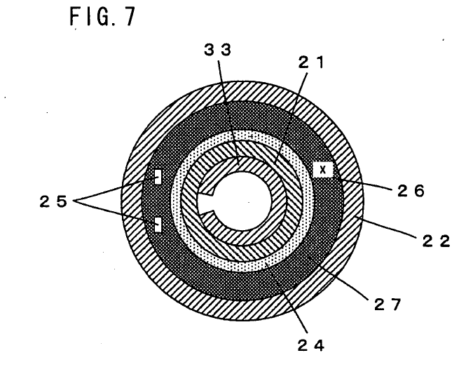

In this embodiment, too, the seal 27 is provided in the region 26 which is defined by the connector 24 and the body 22, with the connecting wire 25 running through the region 26. FIG. 7 is a sectional view taken along line VII-VII in FIG. 6 and shows the state in which the connecting wire 25 and the seal 27 are provided in the region 26.

Further, in this embodiment, the inner space of the fixed core 21 and the inner space of the connector 24 form the fuel passage 21h. Specifically, the inner space of the connector 24 forms the upstream portion of the fuel passage 21h and the inner space of the fixed core 21 forms the downstream portion of the fuel passage 21h. However, it may be configured such that the fuel passage 21h is formed by the inner space of the fixed core 21 alone as shown in FIG. 1.

Various methods may be used to place the connecting wire 25 and the seal 27 in the region 26.

In one method, first, the bobbin 51 is fitted onto the fixed core 21 with the coil 52 which is wound on the bobbin 51 being covered with the resin and with a portion of the connecting wire 25 of which end is connected to the coil 52 being embedded in the resin. At this time, the bobbin 51 is aligned in the circumferential direction such that the connecting wire 25 running from the bobbin 51 is placed in the recess 21b of the flange 21a. Then, with the connecting wire 25 in a predetermined position, the connector 24 is formed of resin on the outer peripheral side of the fixed core 21 such that the recess 24c is formed in the outer peripheral surface of the connector 24. Thus, the connecting wire 25 is embedded in the connector 24. Then, the body 22 is fitted over the bobbin 51. Subsequently, sealing material is filled, through an inlet hole formed in the body 22, into the region 26 that is defined by the recess 24c of the connector 24 and the portion of the body 22 which protrudes upstream from the flange 21a. The sealing material is then hardened. Thus, the seal 27 is provided in the region 26 with the connecting wire 25 running through the region 26.

In another method, first, the fixed core 21, the bobbin 51 and the body 22 are assembled together. In this state, sealing material is filled over the fixed core 21, so that the connector 24 and the seal 27 are formed integrally. Thus, the seal 27 is provided in the region 26 which is defined by the connector 24 and the body 22, with the connecting wire 25 running through the region 26.

In this embodiment, the recess 24c which defines a part of the region 26 is formed of resin, so that the region 26 can be easily formed.

The outer peripheral surface of the end wall 24b may not be in contact with the inner peripheral surface 22b of the body 22. For example, a clearance or seal may be formed between the outer peripheral surface of the end wall 24b and the inner peripheral surface 22b of the body 22.

Further, the end wall 24b may not be provided. For example, the downstream-side surface of the seal 26 may contact the upstream-side surface 21d of the flange 21a. In this case, like in the above-mentioned embodiment, the region for the seal is defined by the fixed core 21 (the flange 21a of the fixed core 21), the body 22 (a portion of the body 22 which protrudes upstream from the flange 21a of the fixed core 21) and the connector 24.

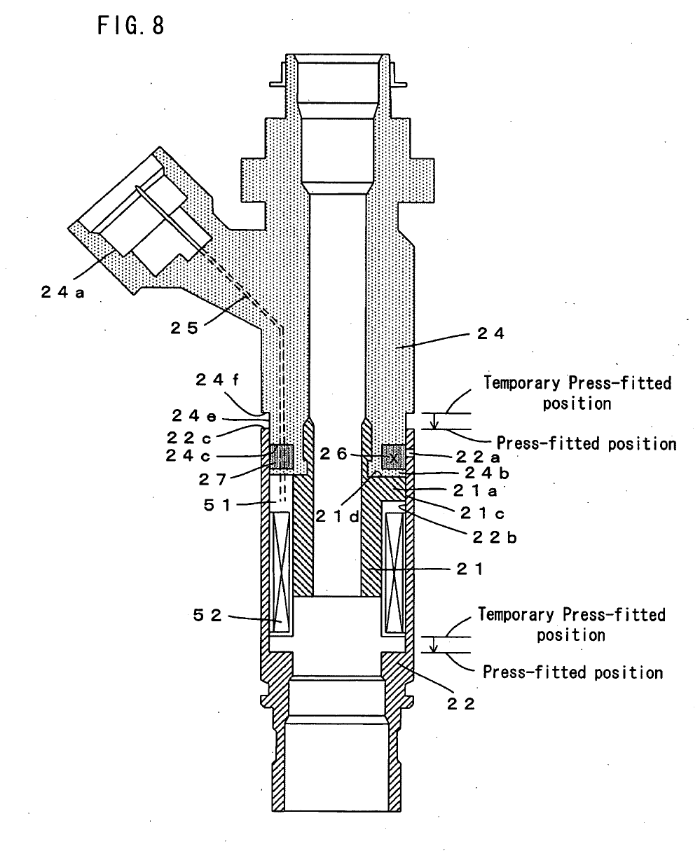

In the above-mentioned methods, it is difficult to provide the seal 27 by filling sealing material having a low viscosity into the region 26 which is surrounded by the body 22 and the connector 24. A method for providing the seal 27 in the region 26 which is surrounded by the body 22 and the connector 24, by using a sealing material having a low viscosity, will now be described with reference to FIG. 8. This method is basically similar to the method described in the first embodiment, and therefore will be explained in brief.

When the sealing method of this embodiment is used, the body 22 as shown in FIG. 8 is used. The upstream-side end surface 22c of the body 22 is located on the upstream side of the normal position of the region 26 which is surrounded by the body 22 and the connector 24. Further, the inlet hole 22a for injecting the sealing material is formed through the body 22 on the upstream side of the normal position of the region 26.

In order to provide the seal 27 in the region 26 which is surrounded by the body 22 and the connector 24, first, the bobbin 51 is fitted onto the fixed core 21 with the coil 52 which is wound on the bobbin 51 being covered with the resin and with a portion of the connecting wire 25 of which end is connected to the coil 52 being embedded in the resin. At this time, the bobbin 51 is aligned in the circumferential direction such that the connecting wire 25 is placed in a predetermined position. Then, in this state, the connector 24 is formed of resin on the outer peripheral side of the fixed core 21 such that the recess 24c is formed in the outer peripheral surface of the connector 24. In this manner, the coil 52, the bobbin 51, the connecting wire 25, the fixed core 21, and the connector 24 are assembled together into one piece (hereinafter referred to as a “fixed core body”). In this state, a region is defined by the recess 24c in the outer peripheral surface of the connector 24.

Subsequently, the fixed core body is press fitted into the body 22 from upstream (from above as viewed in FIG. 8). At this state, the downstream-side outer peripheral surface 24e of the connector 24 contacts the inner peripheral surface 22b of the body 22, so that the region 26 is defined by the recess 24c of the connector 24 and the inner peripheral surface 22b of the body 22.

Then, as shown in FIG. 8, the fixed core body is press fitted into the body 22 in the direction of the arrow until the region 26 reaches a temporary press-fitted position in which the region 26 communicates with the inlet hole 22a of the body 22. Sealing material is then filled into the region 26 through the inlet hole 22a. Thereafter, the fixed core body is further press fitted downstream (in the direction of the arrow) from the temporary press-fitted position to the press-fitted position in which the stepped end surface 24f of the connector 24 abuts on the upstream-side end surface 22c of the body 22. The downstream-side outer peripheral surface 24e of the connector 24 closes the inner end of the inlet hole 22a of the body 22 by the time that the fixed core body is positioned with respect to the body 22 in the press-fitted position.

The present invention is not limited to the constructions that have been described as the representative embodiments, but rather, may be added to, changed, replaced with alternatives or otherwise modified without departing from the spirit and scope of the invention. For example, the seal 27 has been described as being arranged to fill the region 26, but the seal 27 may be arranged in part of the region 26 as long as the inner and outer peripheral surfaces of the region 26 are in contact with the inner and outer peripheral surfaces of the seal 27. The method of defining the region 26 by the fixed core 21, the flange 21a of the fixed core 21, the body 22 and the connector 24 or by the body 22 and the recess 24c of the connector 24 is not limited to the methods described in the representative embodiments, but various methods may be used. The seal 27 and the connector 24 may be formed of the same material or of different materials. The seal 27 and the connector 24 may be formed separately or integrally. The method of placing the connecting wire 25 in the connector 24, the region 26 and the flange 21a is not limited to the methods described in the representative embodiments, but various methods may be used. The construction of the fuel injector is not limited to that of the embodiments. For example, the configurations of the fixed core 21, the body 22, the movable core 31, the bobbin 51, the connector 24, the valve 30 and the valve seat 40 can be appropriately changed. Further, the mechanism for opening and closing the fuel jet opening is not limited to that described in the embodiments.

The fuel injector of this invention can be used as a fuel injector for injecting various kinds of fuel.

Further, the present invention can also be representative as a fuel supply system which includes a fuel tank, a fuel pump and the fuel injector according to the embodiment of this invention.

What we claim is

1. A fuel injector comprising:
a cylindrical fixed core having an inner space that includes a fuel passage,
a movable core that can move with respect to the fixed core,
a valve seat having a fuel jet opening that is caused to open and close by the movement of the movable core,
a coil holding element that is disposed around the fixed core and holds a coil,
a connector that is disposed around the fixed core and in which a connecting wire connected to the coil is embedded,
a body that is disposed around the coil holding element,
a region defined by the connector and the body, and
a seal disposed in the region with the connecting wire running through the seal.

2. The fuel injector as in claim 1, wherein the connector has a recess formed on the outer peripheral surface, and the region is defined by the recess of the connector and the body.

3. The fuel injector as in claim 1, wherein the fixed core has a flange that protrudes radially outward, the coil holding element is disposed on the downstream side of the flange, and the region is disposed on the upstream side of the flange.

4. The fuel injector as in claim 1, wherein the seal is elastic.

5. The fuel injector as in claim 1, wherein the region is defined by the connector and the body and further by the fixed core.

6. The fuel injector as in claim 5, wherein the fixed core has a flange that protrudes radially outward, the coil holding element is disposed on the downstream side of the flange, and the region is disposed on the upstream side of the flange.

7. The fuel injector as in claim 6, wherein the region is defined by the fixed core, the flange of the fixed core, the connector and the body.

8. The fuel injector as in claim 5, wherein the seal is elastic.

9. A fuel injector which is installed into a mounting hole of an intake manifold, the fuel injector comprising:
a cylindrical fixed core having an inner space that includes a fuel passage,
a movable core that can move with respect to the fixed core,
a valve seat having a fuel jet opening that is caused to open and close by the movement of the movable core,
a coil holding element that is disposed around the fixed core and holds a coil,
a connector that is disposed around the fixed core and in which a connecting wire connected to the coil is embedded, and
a body that is disposed around the coil holding element,
wherein the maximum outside diameter of the body is smaller than the minimum inside diameter of the mounting hole of the intake manifold.

10. A method for sealing a fuel injector, the fuel injector including a cylindrical fixed core having an inner space that includes a fuel passage, a movable core that can move with respect to the fixed core, a valve seat having a fuel jet opening that is caused to open and close by the movement of the movable core, a coil holding element that is disposed around the fixed core and folds a coil, a connector that is disposed around the fixed core and in which a connecting wire connected to the coil is embedded, and a body that is disposed around the coil holding element, the method comprising:
positioning the connector with respect to the body such that, in the state in which the connecting wire is placed in a region that is defined by the connector and the body, the region communicates with an inlet hole formed in the body,
filling sealing material into the region through the inlet hole, and
positioning the connector with respect to the body such that the region does not communicate with the inlet hole.

11. The method as in claim 10, wherein the region is defined by the body and a recess formed on the outer peripheral surface of the connector.

12. The method as in claim 10, wherein the fixed core, the coil holding element, the coil, the connecting wire and the connector are assembled together into one piece so as to form a fixed core body and the fixed core body is positioned with respect to the body.

13. The method as in claim 12, wherein the fixed core body is positioned with respect to the body by press-fitting.

14. The method as in claim 10, wherein the region is defined by the connector and the body and further by the fixed core, and the connector and further the fixed core are positioned with respect to the body.

15. The method as in claim 14, wherein the region is defined by the connector, the body, the fixed core, and a flange of the fixed core that protrudes radially outward.

16. The method as in claim 14, wherein the fixed core, the coil holding element, the coil, the connecting wire and the connector are assembled together into one piece so as to form a fixed core body and the fixed core body is positioned with respect to the body.

17. The method as in claim 16, wherein the fixed core body is positioned with respect to the body by press-fitting.
